(19) United States
(12) Patent Application Publication
(10) Pub. No.: US 2025/0232355 A1
(43) Pub. Date: Jul. 17, 2025

(54) NATURAL LANGUAGE PROCESSING (NLP) BASED SYSTEMS AND METHODS FOR RECOMMENDATION OF ITEMS

(71) Applicant: Tata Consultancy Services Limited, Mumbai (IN)

(72) Inventors: SRIDHAR RATHINASABAPATHY, Chennai (IN); PUNEET SACHDEVA, Delhi (IN); PURUSHOTHAMAN RAMASAMY, Chennai (IN)

(73) Assignee: Tata Consultancy Services Limited, Mumbai (IN)

(21) Appl. No.: 19/013,916

(22) Filed: Jan. 8, 2025

(30) Foreign Application Priority Data
Jan. 17, 2024 (IN) 202421003421

(51) Int. Cl. G06Q 30/0601; G06F 40/30

(52) U.S. Cl. CPC G06Q 30/0631; G06F 40/30

(57) ABSTRACT

Conventionally industries delt with diverse categories of products/items recommendation. This gave rise to a display taxonomy for the products. The art of matching products/items with certainty is critical to infer price gaps, which can significantly alter a competitive landscape. Manually comparing product features is time-consuming and error-prone, leading to inaccurate results. Present disclosure provides systems and methods that receive items pertaining to various entities (retail and competitor's) which are pre-processed to obtain pre-processed dataset. Taxonomy codes are tagged to a subset of items amongst pre-processed dataset to obtain code tagged items having attributes. The attributes are converted to feature vectors, and models are built using code tagged items and feature vectors. Using the models, a third set of items is obtained, and features are extracted accordingly. NLP engines process taxonomy code, an associated taxonomy level, and a value of the features for recommending items and are categorized accordingly.

### PRIORITY CLAIM

This U.S. patent application claims priority under 35 U.S.C. § 119 to: Indian Patent Application number 202421003421, filed on Jan. 17, 2024. The entire contents of the aforementioned application are incorporated herein by reference.

### TECHNICAL FIELD

The disclosure herein generally relates to natural language processing (NLP) techniques, and, more particularly, to natural language processing (NLP) based systems and methods for recommendation of items.

### BACKGROUND

Various industries deal with diverse categories of products. For instance, the retail industry has diverse categories of products/items such as food, fashion, alcohol, dairy, pantries, electronics, health, beauty, home improvement, office supplies, footwear, furniture, and so on. These categories are further sub-divided into multiple sub-categories with many levels to drill down with finer nuances of products. This gives rise to a display taxonomy for the products on e-commerce websites. This taxonomy may be either shallow or deep, based on a scheme of things.

With the ever-increasing width and depth of assortment in the digital era, it is essential to understand how a product is placed in terms of price, offers, discounts, and so on, in comparison to competitors. This intelligence is required on a real-time or near-real-time basis, to stay competitive and relevant to consumers. Hence, matching similar items from competitors' vast gamut of products is quite challenging.

The complexity of product matching comes to the fore as there is no specified standard for the attributes used in product definition, hence the same varies with each competitor. The descriptions and images vary extensively, and language also differs if competitors are spread across geographies. The art of matching products with certainty is critical to infer price gaps, which can significantly alter a retailer's competitive landscape. Manually comparing product features is time-consuming and error-prone, leading to inaccurate results.

### SUMMARY

Embodiments of the present disclosure present technological improvements as solutions to one or more of the above-mentioned technical problems recognized by the inventors in conventional systems.

For example, in one aspect, there is provided a processor implemented method for recommendation of items. The method comprises receiving, via one or more hardware processors, information comprising a first set of items pertaining to a first entity, and a second set of items pertaining to a second entity; pre-processing, via the one or more hardware processors, the information comprising the first set of items pertaining to the first entity and the second set of items pertaining to the second entity to obtain a pre-processed dataset; obtaining, via the one or more hardware processors, a taxonomy code to at least a subset of items amongst the pre-processed dataset to obtain a set of code tagged items, wherein each code tagged item amongst the set of code tagged items is associated with one or more attributes; converting, by using a sentence encoder via the one or more hardware processors, the one or more attributes comprised in the set of code tagged items into a feature vector, wherein the feature vector is associated with the first set of items and the second set of items; building, via the one or more hardware processors, a first model and a second model using the set of code tagged items and the feature vector; predicting, by using the first model and the second model via the one or more hardware processors, (i) a first taxonomy level-based value, and (ii) the taxonomy code for each remaining item amongst the pre-processed dataset, respectively to obtain a third set of items; extracting, via the one or more hardware processors, one or more features from the subset of items, and the third set of items; processing, via the one or more hardware processors, the taxonomy code, an associated taxonomy level, and a value associated with the one or more features in a plurality of natural language processing (NLP) engines to obtain a first set of recommended items; applying, via the one more hardware processors, one or more rules on the first set of recommended items to obtain a fourth set of items, wherein each rule is associated with at least one NLP engine amongst the plurality of NLP engines; grouping, via the one more hardware processors, one or more items from the fourth set of items into one or more categories; and recommending, via the one or more hardware processors, at least a subset of items amongst the fourth set of items to obtain a second set of recommended items, wherein the second set of recommended items is based on a weightage associated to each of the plurality of NLP engines.

In an embodiment, the step of obtaining the taxonomy code is based on at least one of an associated item category and an associated item sub-category.

In an embodiment, the step of extracting the one or more features from the subset of items, and the third set of items comprises concatenating one or more attributes associated with the subset of items, and the third set of items; obtaining a predefined attribute value for each taxonomy code of the subset of items, and the third set of items; performing a comparison of keywords between the subset of items, and the third set of items; and extracting the one or more features from the subset of items, and the third set of items based on the comparison and the predefined attribute value.

In an embodiment, the step of processing by a first NLP engine amongst the plurality of NLP engines comprises filtering the second set of items for each item comprised in the first set of items based on the taxonomy code; creating a feature summary for the first set of items and the second set of items based on the value of the one or more features; converting the feature summary into the feature vector of the first set of items and the second set of items; computing a cosine similarity score for the first set of items and the second set of items based on the feature vector of the first set of items and the second set of items; and obtaining the first set of recommended items based on the cosine similarity score.

In an embodiment, wherein the step of processing by a second NLP engine amongst the plurality of NLP engines comprises for each taxonomy code: traversing through the associated taxonomy level for determining a match between an item of the first set of items and an item of the second set of items to obtain a set of level-based items; concatenating one or more attributes of the set of level-based items to obtain a set of concatenated attributes; converting the set of concatenated attributes into the feature vector of the first set of items and the second set of items; computing a cosine distance score between the first set of items and the second set of items based on the feature vector of the first set of items and the second set of items; computing a taxonomy based matching score based on the cosine distance score; and obtaining the first set of recommended items based on the taxonomy based matching score.

In an embodiment, the step of processing by a third NLP engine amongst the plurality of NLP engines comprises creating an index of the second set of items; identifying a semantic match for a query item associated with the first set of items in the index of the second set of items; computing a semantic matching score based on the semantic match; and obtaining the first set of recommended items based on the semantic matching score.

In an embodiment, the step of processing by a fourth NLP engine amongst the plurality of NLP engines comprises performing a comparison of a name associated with each item amongst the first of items with each item amongst the second of items; computing a string matching score based on the comparison; and obtaining the first set of recommended items based on the string matching score.

In an embodiment, the step of grouping, comprises grouping one or more items into a first category based on an item comprised in the first set of recommended items that is recommended by a first combination of NLP engines; grouping one or more items into a second category based on an item comprised in the first set of recommended items that is recommended by a second combination of NLP engines; grouping one or more items into a third category based on an item comprised in the first set of recommended items that is recommended by a third combination of NLP engines; and grouping one or more items into a fourth category based on an item comprised in the first set of recommended items that is recommended by a NLP engine.

In an embodiment, the weightage associated to each of the plurality of NLP engines is determined based on a match of an item comprised in the fourth set of items with an associated item amongst the second set of items.

In an embodiment, the method further comprises updating the weightage of each of the plurality of NLP engines based on a comparison of (i) one or more items amongst the second set of recommended items, and (ii) a fifth set of items; and sorting the second set of recommended items based on the updated weightage.

In another aspect, there is provided a processor implemented system for recommendation of items. The system comprises: a memory storing instructions; one or more communication interfaces; and one or more hardware processors coupled to the memory via the one or more communication interfaces, wherein the one or more hardware processors are configured by the instructions to receive information comprising a first set of items pertaining to a first entity, and a second set of items pertaining to a second entity; pre-process the information comprising the first set of items pertaining to the first entity and the second set of items pertaining to the second entity to obtain a pre-processed dataset; obtain a taxonomy code to at least a subset of items amongst the pre-processed dataset to obtain a set of code tagged items, wherein each code tagged item amongst the set of code tagged items is associated with one or more attributes; convert, by using a sentence encoder, the one or more attributes comprised in the set of code tagged items into a feature vector, wherein the feature vector is associated with the first set of items and the second set of items; building, via the one or more hardware processors, a first model and a second model using the set of code tagged items and the feature vector; predicting, by using the first model and the second model, (i) a first taxonomy level-based value, and (ii) the taxonomy code for each remaining item amongst the pre-processed dataset, respectively to obtain a third set of items; extract, one or more features from the subset of items, and the third set of items; process the taxonomy code, an associated taxonomy level, and a value associated with the one or more features in a plurality of natural language processing (NLP) engines to obtain a first set of recommended items; apply one or more rules on the first set of recommended items to obtain a fourth set of items, wherein each rule is associated with at least one NLP engine amongst the plurality of NLP engines; group one or more items from the fourth set of items into one or more categories; and recommend at least a subset of items amongst the fourth set of items to obtain a second set of recommended items, wherein the second set of recommended items is based on a weightage associated to each of the plurality of NLP engines.

In an embodiment, the taxonomy code is obtained based on at least one of an associated item category and an associated item sub-category.

In an embodiment, the one or more features are extracted from the subset of items, and the third set of items by concatenating one or more attributes associated with the subset of items, and the third set of items; obtaining a predefined attribute value for each taxonomy code of the subset of items, and the third set of items; performing a comparison of keywords between the subset of items, and the third set of items; and extracting the one or more features from the subset of items, and the third set of items based on the comparison and the predefined attribute value.

In an embodiment, a first NLP engine amongst the plurality of NLP engines processes the taxonomy code, the associated taxonomy level, and the value associated with the one or more features by filtering the second set of items for each item comprised in the first set of items based on the taxonomy code; creating a feature summary for the first set of items and the second set of items based on the value of the one or more features; converting the feature summary into the feature vector of the first set of items and the second set of items; computing a cosine similarity score for the first set of items and the second set of items based on the feature vector of the first set of items and the second set of items; and obtaining the first set of recommended items based on the cosine similarity score.

In an embodiment, a second NLP engine amongst the plurality of NLP engines processes the taxonomy code, the associated taxonomy level, and the value associated with the one or more features by performing for each taxonomy code: traversing through the associated taxonomy level for determining a match between an item of the first set of items and an item of the second set of items to obtain a set of level-based items; concatenating one or more attributes of the set of level-based items to obtain a set of concatenated attributes; converting the set of concatenated attributes into the feature vector of the first set of items and the second set of items; computing a cosine distance score between the first set of items and the second set of items based on the feature vector of the first set of items and the second set of items; computing a taxonomy based matching score based on the cosine distance score; and obtaining the first set of recommended items based on the taxonomy based matching score.

In an embodiment, a third NLP engine amongst the plurality of NLP engines processes the taxonomy code, the associated taxonomy level, and the value associated with the one or more features by creating an index of the second set of items; identifying a semantic match for a query item associated with the first set of items in the index of the second set of items; computing a semantic matching score based on the semantic match; and obtaining the first set of recommended items based on the semantic matching score.

In an embodiment, a fourth NLP engine amongst the plurality of NLP engines processes the taxonomy code, the associated taxonomy level, and the value associated with the one or more features by performing a comparison of a name associated with each item amongst the first of items with each item amongst the second of items; computing a string matching score based on the comparison; and obtaining the first set of recommended items based on the string matching score.

In an embodiment, the one or more categories are obtained by grouping one or more items into a first category based on an item comprised in the first set of recommended items that is recommended by a first combination of NLP engines; grouping one or more items into a second category based on an item comprised in the first set of recommended items that is recommended by a second combination of NLP engines; grouping one or more items into a third category based on an item comprised in the first set of recommended items that is recommended by a third combination of NLP engines; and grouping one or more items into a fourth category based on an item comprised in the first set of recommended items that is recommended by a NLP engine.

In an embodiment, the weightage associated to each of the plurality of NLP engines is determined based on a match of an item comprised in the fourth set of items with an associated item amongst the second set of items.

In an embodiment, the one or more hardware processors are further configured by the instructions to update the weightage of each of the plurality of NLP engines based on a comparison of (i) one or more items amongst the second set of recommended items, and (ii) a fifth set of items; and sort the second set of recommended items based on the updated weightage.

In yet another aspect, there are provided one or more non-transitory machine-readable information storage mediums comprising one or more instructions which when executed by one or more hardware processors cause recommendation of items by receiving information comprising a first set of items pertaining to a first entity, and a second set of items pertaining to a second entity; pre-processing the information comprising the first set of items pertaining to the first entity and the second set of items pertaining to the second entity to obtain a pre-processed dataset; obtaining a taxonomy code to at least a subset of items amongst the pre-processed dataset to obtain a set of code tagged items, wherein each code tagged item amongst the set of code tagged items is associated with one or more attributes; converting, by using a sentence encoder, the one or more attributes comprised in the set of code tagged items into a feature vector, wherein the feature vector is associated with the first set of items and the second set of items; building a first model and a second model using the set of code tagged items and the feature vector; predicting, by using the first model and the second model, (i) a first taxonomy level-based value, and (ii) the taxonomy code for each remaining item amongst the pre-processed dataset, respectively to obtain a third set of items; extracting one or more features from the subset of items, and the third set of items; processing the taxonomy code, an associated taxonomy level, and a value associated with the one or more features in a plurality of natural language processing (NLP) engines to obtain a first set of recommended items; applying, via the one more hardware processors, one or more rules on the first set of recommended items to obtain a fourth set of items, wherein each rule is associated with at least one NLP engine amongst the plurality of NLP engines; grouping, via the one more hardware processors, one or more items from the fourth set of items into one or more categories; and recommending at least a subset of items amongst the fourth set of items to obtain a second set of recommended items, wherein the second set of recommended items is based on a weightage associated to each of the plurality of NLP engines.

In an embodiment, the step of obtaining the taxonomy code is based on at least one of an associated item category and an associated item sub-category.

In an embodiment, the step of extracting the one or more features from the subset of items, and the third set of items comprises concatenating one or more attributes associated with the subset of items, and the third set of items; obtaining a predefined attribute value for each taxonomy code of the subset of items, and the third set of items; performing a comparison of keywords between the subset of items, and the third set of items; and extracting the one or more features from the subset of items, and the third set of items based on the comparison and the predefined attribute value.

In an embodiment, the step of processing by a first NLP engine amongst the plurality of NLP engines comprises filtering the second set of items for each item comprised in the first set of items based on the taxonomy code; creating a feature summary for the first set of items and the second set of items based on the value of the one or more features; converting the feature summary into the feature vector of the first set of items and the second set of items; computing a cosine similarity score for the first set of items and the second set of items based on the feature vector of the first set of items and the second set of items; and obtaining the first set of recommended items based on the cosine similarity score.

In an embodiment, the step of processing by a second NLP engine amongst the plurality of NLP engines comprises for each taxonomy code: traversing through the associated taxonomy level for determining a match between an item of the first set of items and an item of the second set of items to obtain a set of level-based items; concatenating one or more attributes of the set of level-based items to obtain a set of concatenated attributes; converting the set of concatenated attributes into the feature vector of the first set of items and the second set of items; computing a cosine distance score between the first set of items and the second set of items based on the feature vector of the first set of items and the second set of items; computing a taxonomy based matching score based on the cosine distance score; and obtaining the first set of recommended items based on the taxonomy based matching score.

In an embodiment, the step of processing by a third NLP engine amongst the plurality of NLP engines comprises creating an index of the second set of items; identifying a semantic match for a query item associated with the first set of items in the index of the second set of items; computing a semantic matching score based on the semantic match; and obtaining the first set of recommended items based on the semantic matching score.

In an embodiment, the step of processing by a fourth NLP engine amongst the plurality of NLP engines comprises performing a comparison of a name associated with each item amongst the first of items with each item amongst the second of items; computing a string matching score based on the comparison; and obtaining the first set of recommended items based on the string matching score.

In an embodiment, the step of grouping comprises grouping one or more items into a first category based on an item comprised in the first set of recommended items that is recommended by a first combination of NLP engines; grouping one or more items into a second category based on an item comprised in the first set of recommended items that is recommended by a second combination of NLP engines; grouping one or more items into a third category based on an item comprised in the first set of recommended items that is recommended by a third combination of NLP engines; and grouping one or more items into a fourth category based on an item comprised in the first set of recommended items that is recommended by a NLP engine.

In an embodiment, the weightage associated to each of the plurality of NLP engines is determined based on a match of an item comprised in the fourth set of items with an associated item amongst the second set of items.

In an embodiment, the instructions which when executed by the one or more hardware processors further cause updating the weightage of each of the plurality of NLP engines based on a comparison of (i) one or more items amongst the second set of recommended items, and (ii) a fifth set of items; and sorting the second set of recommended items based on the updated weightage.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 depicts an exemplary natural language processing (NLP) based system for recommendation of items, in accordance with an embodiment of the present disclosure.

FIG. 2 depicts an exemplary high level block diagram of the NLP based system of FIG. 1 for recommendation of items, in accordance with an embodiment of the present disclosure.

FIGS. 3A and 3B depict an exemplary flow chart illustrating a NLP based method for recommendation of items, using the systems of FIGS. 1-2, in accordance with an embodiment of the present disclosure.

FIG. 4 depicts an exemplary merchandise taxonomy, in accordance with an embodiment of the present disclosure.

FIG. 5 depicts a graphical representation of recalled percentage against labelled matches of items, in accordance with an embodiment of the present disclosure.

FIG. 6 depicts a graphical representation illustrating time taken for item matching (throughput) by the method of the present disclosure and conventional approach(es), in accordance with an embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

As mentioned earlier, industries deal with diverse categories of products. For instance, the retail industry has diverse categories of products/items such as food, fashion, alcohol, dairy, pantries, electronics, health, beauty, home improvement, office supplies, footwear, furniture, and so on. These categories are further sub-divided into multiple sub-categories with many levels to drill down with finer nuances of products. This gives rise to a display taxonomy for the products on e-commerce websites. This taxonomy may be either shallow or deep, based on a scheme of things.

The complexity of product matching comes to the fore as there is no specified standard for the attributes used in product definition, hence the same varies with each competitor. The descriptions and images vary extensively, and language also differs if competitors are spread across geographies. The art of matching products with certainty is critical to infer price gaps, which can significantly alter a retailer's competitive landscape. Manually comparing product features is time-consuming and error-prone, leading to inaccurate results.

Embodiments of the present disclosure provide systems and methods that implement various natural language processing (NLP) engines for recommendation of items. More specifically, items (e.g., first set of items and second set of items) pertaining to various entities (e.g., say retail and competitor's) are fed as input to the system and pre-processed to obtain pre-processed dataset. Taxonomy code are then tagged to at least to a subset of items amongst the pre-processed dataset to obtain code tagged items. The code tagged items have one or more associated attributes. The attributes are then converted to feature vectors which are associated with items of the entities. Further, specific models are built using the code tagged items and feature vectors. Using the specific models, (i) a first taxonomy level-based value, and (ii) the taxonomy code are predicted for each remaining item amongst the pre-processed dataset, respectively to obtain a third set of items. Further, features are extracted from the subset of items and the third set of items. Further, the system 100 implements a plurality of NLP engines which process the taxonomy code, an associated taxonomy level, and a value associated with the one or more features in the NLP engines to obtain a first set of recommended items. Rules are then applied on the first set of recommended items to obtain a fourth set of items and items from the fourth set are grouped into various categories for further recommendation of items (e.g., also referred to as second set of recommended items). This second set of recommended items is provided to the first entity (e.g., say a retailer) who can then analyse and perform a price and offer analysis in view of the second set of items of the second entity (e.g., say competition).

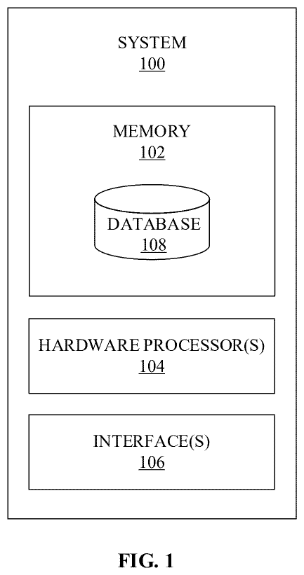

Referring now to the drawings, and more particularly to FIGS. 1 through 6, where similar reference characters denote corresponding features consistently throughout the figures, there are shown preferred embodiments and these embodiments are described in the context of the following exemplary system and/or method.

FIG. 1 depicts an exemplary natural language processing (NLP) based system 100 for recommendation of items, in accordance with an embodiment of the present disclosure. In an embodiment, the system 100 may also be referred to as ‘recommendation system’ or ‘items recommendation system’ and may be interchangeably used herein. In an embodiment, the system 100 includes one or more hardware processors 104, communication interface device(s) or input/output (I/O) interface(s) 106 (also referred as interface(s)), and one or more data storage devices or memory 102 operatively coupled to the one or more hardware processors 104. The one or more processors 104 may be one or more software processing components and/or hardware processors. In an embodiment, the hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is/are configured to fetch and execute computer-readable instructions stored in the memory. In an embodiment, the system 100 can be implemented in a variety of computing systems, such as laptop computers, notebooks, hand-held devices (e.g., smartphones, tablet phones, mobile communication devices, and the like), workstations, mainframe computers, servers, a network cloud, and the like.

The I/O interface device(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 102 may include any computer-readable medium known in the art including, for example, volatile memory, such as static random-access memory (SRAM) and dynamic-random access memory (DRAM), and/or non-volatile memory, such as read only memory (ROM), erasable programmable ROM, flash memories, hard disks, optical disks, and magnetic tapes. In an embodiment, a database 108 is comprised in the memory 102, wherein the database 108 comprises information of items, associated categories pertaining to various entities (e.g., entity 1, entity 2, and so on). The database 108 further comprises taxonomy codes, taxonomy levels, attributes of the items, feature vectors of the items, and the like. The memory 102 stores various NLP engines which when executed enable the system 100 to perform specific operations/steps of the method described herein. The memory 102 further comprises (or may further comprise) information pertaining to input(s)/output(s) of each step performed by the systems and methods of the present disclosure. In other words, input(s) fed at each step and output(s) generated at each step are comprised in the memory 102 and can be utilized in further processing and analysis.

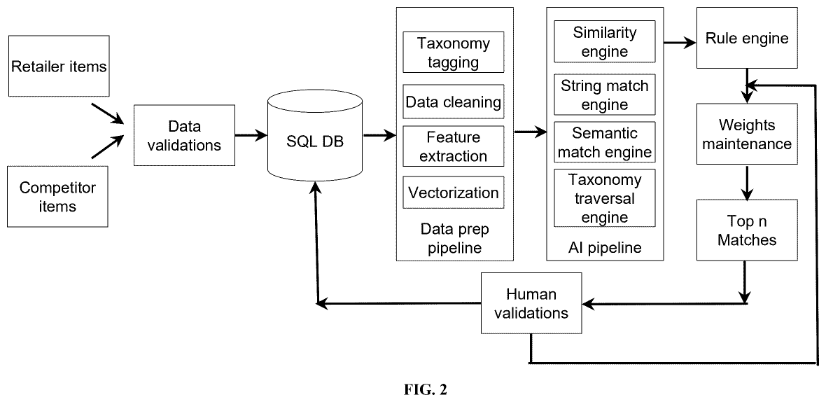

FIG. 2, with reference to FIG. 1, depicts an exemplary high level block diagram of the NLP based system 100 of FIG. 1 for recommendation of items, in accordance with an embodiment of the present disclosure.

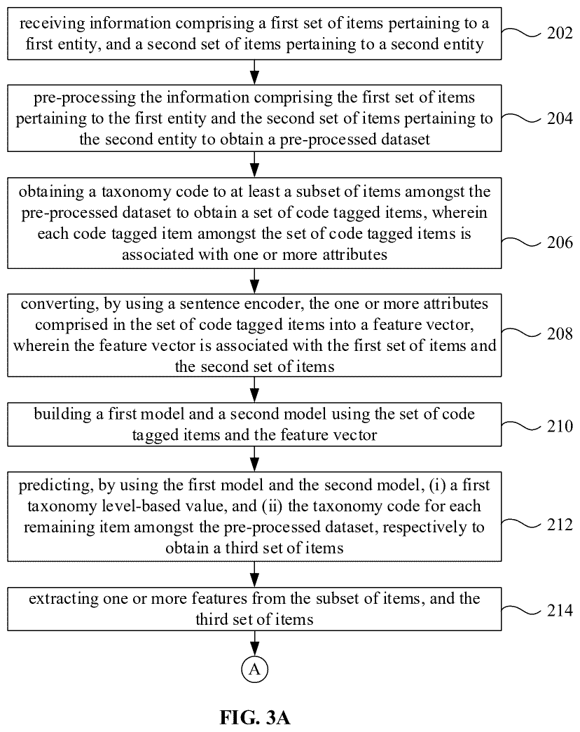

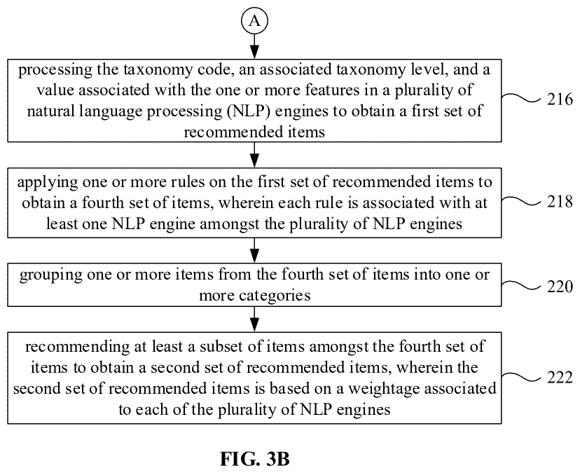

FIGS. 3A and 3B, with reference to FIGS. 1 and 2, depict an exemplary flow chart illustrating a NLP based method for recommendation of items, using the systems 100 of FIGS. 1-2, in accordance with an embodiment of the present disclosure. In an embodiment, the system(s) 100 comprises one or more data storage devices or the memory 102 operatively coupled to the one or more hardware processors 104 and is configured to store instructions for execution of steps of the method by the one or more processors 104. The steps of the method of the present disclosure will now be explained with reference to components of the system 100 of FIG. 1, the block diagram of the system 100 depicted in FIG. 2, and the flow diagram as depicted in FIGS. 3A and 3B. Although process steps, method steps, techniques or the like may be described in a sequential order, such processes, methods, and techniques may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

At step 202 of the method of the present disclosure, the one or more hardware processors 104 receive information comprising a first set of items pertaining to a first entity, and a second set of items pertaining to a second entity. The items may include but are not limited to products sold/selling/or to be sold by the first entity and the second entity. In an embodiment, the first entity may be a retailer and the second entity may be a competitor (also referred to as a competition). It is to be understood by a person having ordinary skill in the art or person skilled in the art that such examples of items pertaining to products in retail domain shall not be construed as limiting the scope of present disclosure. In other words, the system 100 and the method of the present disclosure may be implemented across industry domains (e.g., manufacturing, healthcare, information technology, and so on), including for services sold/selling/or to be sold by various entities.

The first set of items (e.g., retailer items) and the second set of items (e.g., competitor's items) are fed as an input to the system 100 as depicted in FIG. 2. Such items information may be obtained in the form of metadata, in one example embodiment. Below Table 1 and Table 2 depict the first set of items (e.g., retailer items) and the second set of items (e.g., competitor's items), respectively.

TABLE 1
(retailer's items)

| | | Country | | tradeitem- |
|---|---|---|---|---|
| | Party | of | description- | measurement_{—} |
| GLN | name | origin | short | packingunit |
| 4053213000110 | XYZLLC | CN | Gamestation | EA |
| 4053213000110 | XYZLLC | CN | Gamestation_{—} | EA |
| | | | xshock | |
| . . . | . . . | . . . | . . . | . . . |
| 4053213000110 | XYZLLC | CN | Tausunkt | EA |

TABLE 2
(competitor's items)

| | | Country | | |
|---|---|---|---|---|
| | Competitor | of | | Store |
| GLN | name | origin | descriptionshort | address |
| 2005105007507 | ABC | USA | X-MEN Active | Loca- |
| | Corp | | Protect | tion 1 |
| | | | ajÃᵢndÃ ©kcsomag | |
| 2005105006613 | ABC | USA | Green Mojito & | Loca- |
| | Corp | | Cedarwood | tion 1 |
| | | | ajÃᵢndÃ ©kcsomag | |
| | | | vilÃᵢgÃ- | |
| | | | tÃ³ | |
| | | | cipÅ‘fÅ±zÅ‘vel | |
| . . . | . . . | . . . | . . . | . . . |
| 2005105007508 | ABC | USA | X-MEN Men Fresh | Loca- |
| | Corp | | ajÃᵢndÃ ©kcsomag | tion 1 |

It is to be understood by a person having ordinary skill in the art or person skilled in the art that such examples of items pertaining to the first entity and the second entity shall not be construed as limiting the scope of present disclosure. It is to be understood by a person having ordinary skill in the art or person skilled in the art that information obtained as in the above tables shall not be construed as limiting the scope of present disclosure. In other words, other details such as ingredients, net content, online activity, purchasing group, validity, supplier identifier, supplier name, and the like may also be obtained. For the sake of brevity only fewer details are shown in the above Tables 1 and 2.

At step 204 of the method of the present disclosure, the one or more hardware processors 104 pre-process the information comprising the first set of items pertaining to the first entity and the second set of items pertaining to the second entity to obtain a pre-processed dataset. Below Tables 3 and 4 depict the pre-processed dataset pertaining to the first entity and the second entity.

TABLE 3
(pre-processed dataset of first entity)

| | | | | variant_{—} | | country_{—} | |
|---|---|---|---|---|---|---|---|
| item_id | product_name | Code | brand_name | brandname | brand_type | of_origin | allergen |
| 863 | Primel | 543564 | Brand 1 | NULL | Private | Hungary | NULL |
| | | | | | Label | | |
| 969 | Salatpflanzen | 6762 | Brand 2 | NULL | Private | Austria | NULL |
| | | | | | Label | | |
| 1058 | Kindersnackgemüse | 543560 | Brand 3 | NULL | Private | Austria | NULL |
| | | | | | Label | | |
| 1059 | Fruchtgemüse | 543560 | Brand 4 | NULL | Private | Austria | NULL |
| | | | | | Label | | |
| 1060 | Tomatenraritaeten | 543560 | Brand 5 | NULL | Private | Austria | NULL |
| | | | | | Label | | |
| . . . | . . . | . . . | . . . | . . . | . . . | . . . | . . . |
| 1374 | Schilchersturm 1.5 l | 9654 | Brand 8 | NULL | Private | Austria | Enthält |
| | | | | | Label | | Sulfite |

TABLE 4
(pre-processed dataset of second entity)

| item_id | product_name | GTCode | brand_name | brand_type | country_of_origin | allergen |
|---|---|---|---|---|---|---|
| 1 | Mayonnaise | 1568 | Brand 20 | Manufacturer | NULL | Eier und |
| | 50% Fett | | | | | daraus |
| | 0.5 L | | | | | gewonnene |
| | | | | | | Erzeugnisse, |
| | | | | | | Senf und |
| | | | | | | daraus |
| | | | | | | gewonnene |
| | | | | | | Erzeugnisse |
| 2 | Leicht | 1568 | Brand 21 | Manufacturer | NULL | Eier und |
| | Mayonnaise | | | | | daraus |
| | 25% Fett | | | | | gewonnene |
| | 33 Portionen | | | | | Erzeugnisse, |
| | 0.5 L | | | | | Senf und |
| | | | | | | daraus |
| | | | | | | gewonnene |
| | | | | | | Erzeugnisse |
| 3 | Bio- | 2126 | Brand 22 | PrivateLabel | Sorgfältig | NULL |
| | Rapsöl | | | | hergestellt in | |
| | kaltgepresst | | | | Deutschland | |
| | 0.5 L | | | | | |
| 4 | Bio- | 2126 | Brand 23 | PrivateLabel | Sorgfältig | NULL |
| | Sonnenblumenol | | | | hergestellt in | |
| | kaltgepresst | | | | Österreich | |
| | 0.5 L | | | | | |
| 5 | Darbo | 9050 | Brand 24 | Manufacturer | NULL | NULL |
| | Sommersirup | | | | | |
| | Holunderblüte | | | | | |
| | Minze | | | | | |
| | 0.5 L | | | | | |
| . . . | . . . | . . . | . . . | . . . | . . . | . . . |
| 16 | Elit Elit 0.5 L | 2107 | Brand 29 | Manufacturer | Lettland | NULL |

It is to be understood by a person having ordinary skill in the art or person skilled in the art that items pertaining to the first entity and the second entity for Tables 1, 2, 3, and 4 are shown in different format and details for better understanding of the embodiments described herein and such examples shall not be construed as limiting the scope of present disclosure.

At step 206 of the method of the present disclosure, the one or more hardware processors 104 obtain a taxonomy code (also referred to as ‘tc’ or ‘tcode’ and may be interchangeably used herein) to at least a subset of items amongst the pre-processed dataset to obtain a set of code tagged items. In an embodiment, each code tagged item amongst the set of code tagged items is associated with one or more attributes. The taxonomy code is based on at least one of an associated item category and an associated item sub-category. Table 5 depicts items of various categories, and sub-categories at various taxonomy levels (e.g., say L1, L2, L3, . . . . L7, and so on).

TABLE 5

| | | | | | | | | | | Taxonomy | |
|---|---|---|---|---|---|---|---|---|---|---|---|
| category | subcategory | L1 | L2 | L3 | L4 | L5 | L6 | L7 | taxonomyList | code | TaxonomyName |
| Food, | Food | 412 | 422 | 433 | 0 | 0 | 0 | 0 | [412, 422, | 433 | Nuts & |
| Beverages | Items | | | | | | | | 433, 0, 0, 0, 0] | | Seeds |
| & Tobacco | | | | | | | | | | | |
| Food, | Food | 412 | 422 | 427 | 1568 | 0 | 0 | 0 | [412, 422, | 1568 | Mayonnaise |
| Beverages | Items | | | | | | | | 427, 1568, | | |
| & Tobacco | | | | | | | | | 0, 0, 0] | | |
| Health & | Personal | 469 | 2915 | 473 | 474 | 2747 | 0 | 0 | [469, 2915, | 2747 | Body |
| Beauty | Care | | | | | | | | 473, 474, | | Wash |
| | | | | | | | | | 2747, 0, 0] | | |
| Food, | Food | 412 | 422 | 2660 | 2126 | 0 | 0 | 0 | [412, 422, | 2126 | Cooking |
| Beverages | Items | | | | | | | | 2660, 2126, | | Oils |
| & Tobacco | | | | | | | | | 0, 0, 0] | | |
| Food, | Food | 412 | 422 | 428 | 1954 | 9503 | 0 | 0 | [412, 422, | 9503 | yogurt, |
| Beverages | Items | | | | | | | | 428, 1954, | | fruit |
| & Tobacco | | | | | | | | | 9503, 0, 0] | | |
| . . . | . . . | . . . | . . . | . . . | . . . | . . . | . . . | . . . | . . . | . . . | . . . |
| Food, | Food | 412 | 422 | 428 | 429 | 30002820 | 0 | 0 | [412, 422, | 30002820 | GRATED |
| Beverages | Items | | | | | | | | 428, 429, | | |
| & Tobacco | | | | | | | | | 30002820, | | |
| | | | | | | | | | 0, 0] | | |

TABLE 6

| | | | brand_{—} | | country_of_{—} | | product_{—} | | |
|---|---|---|---|---|---|---|---|---|---|
| item_id | product_name | TaxonomyCode | name | brand_type | origin | competitor_id | details | . . . | allergens |
| 1 | Mayonnaise | 1568 | Brand 11 | Manufacturer | NULL | 41 | - mit | . . . | Eier und |
| | 50% Fett | | | | | | Freiland- . . . | | daraus |
| | 0.5 L | | | | | | oder im | | gewonnene |
| | | | | | | | Glas. | | Erzeugnisse, |
| | | | | | | | | | Senf und |
| | | | | | | | | | daraus |
| | | | | | | | | | gewonnene |
| | | | | | | | | | Erzeugnisse |
| . . . 2 | Leicht | 1568 | Brand 12 | Manufacturer | NULL | 41 | macht | . . . | Eier und |
| | Mayonnaise | | | | | | das . . . | | daraus |
| | 25% | | | | | | Eiern | | gewonnene |
| | Fett 33 | | | | | | | | Erzeugnisse, |
| | Portionen | | | | | | | | Senf und |
| | 0.5 L | | | | | | | | daraus |
| | | | | | | | | | gewonnene |
| | | | | | | | | | Erzeugnisse |
| 3 | Bio- | 2126 | Brand 13 | PrivateLabel | Sorgfältig | 41 | Das | . . . | NULL |
| | Rapsöl | | | | hergestellt in | | Bio- | | |
| | kaltgepresst | | | | Deutschland | | Rapsöl . . . | | |
| | 0.5 L | | | | | | Salat- | | |
| | | | | | | | dressings. | | |
| 4 | Bio- | 2126 | Brand 14 | PrivateLabel | Sorgfältig | 41 | 100% | . . . | NULL |
| | Sonnenblumenöl | | | | hergestellt in | | Qualität . . . | | |
| | kaltgepresst | | | | Österreich | | Gemüse. | | |
| | 0.5 L | | | | | | | | |
| 5 | Darbo | 9050 | Brand 15 | Manufacturer | NULL | 41 | . . . | . . . | NULL |
| | Sommersirup | | | | | | | | |
| | Holunderblüte | | | | | | | | |
| | Minze | | | | | | | | |
| | 0.5 L | | | | | | | | |
| 7 | Rauch Happy | 9061 | Brand 16 | Manufacturer | NULL | 41 | NULL | . . . | NULL |
| | Day Mango | | | | | | | | |
| | Sprizz 0.5 L | | | | | | | | |
| 11 | Green Tea | 30001297 | Brand 17 | Manufacturer | NULL | 41 | NULL | . . . | NULL |
| | with Honey | | | | | | | | |
| | 0.5 L | | | | | | | | |
| 14 | Mautner | 2140 | Brand 18 | Manufacturer | Österreich | 41 | Hesperiden | . . . | Schwefeldioxid |
| | Markhof | | | | | | Essig ist | | und Sulphite |
| | Hesperiden | | | | | | eine . . . | | |
| | Essig 0.5 L | | | | | | len. | | |
| 15 | Doppelherz aktiv | 525 | Brand 19 | Manufacturer | NULL | 41 | Eisen ist | . . . | NULL |
| | Eisen Vital | | | | | | ein . . . | | |
| | flüssig 0.5 L | | | | | | werden. | | |

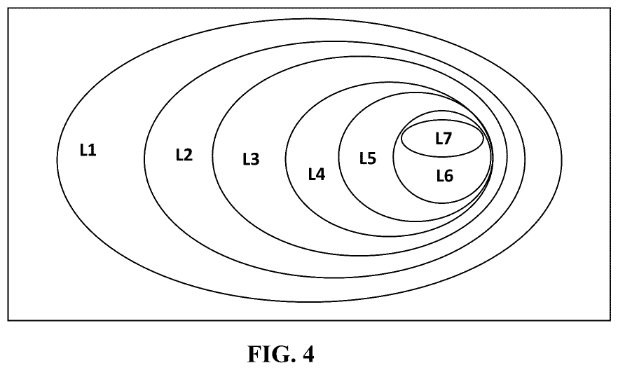

FIG. 4, with reference to FIGS. 1 through 3B, depicts an exemplary merchandise taxonomy, in accordance with an embodiment of the present disclosure. Every item is tagged with the merchandise taxonomy code from levels L1 through L7 based on the applicability. Some items can have codes tagged to all 7 levels and some may have just (m-n) levels also. The leaf node represents the taxonomy code to start the item matching. The relationship among levels is shown below:
L7⊆L6⊆L5⊆L4⊆L3⊆L2⊆L1

At step 208 of the method of the present disclosure, the one or more hardware processors 104 convert, by using a sentence encoder, the one or more attributes comprised in the set of code tagged items into a feature vector. The feature vector is associated with the first set of items and the second set of items. Below Table 7 and Table 8 depict conversion of attributes into a feature vector for both the first entity and the second entity, respectively.

TABLE 7
(item of first entity after vectorization - feature vector)

| seller | item | | Taxonomy | brand | additional | feature | bread | unit | unit | bio_{—} | clean |
|---|---|---|---|---|---|---|---|---|---|---|---|
| Id | Id | L1 | Code | Name | String | String | crumbs | Name | Measure | flag | FeatureString |
| 41 | 10547 | 412 | 9120 | | https://www.inter.at/ | lachs- | startseite > | g | 250 | 0 | lachs filets |
| | | | | | shop/lebensmittel/ | filets | produkte > | | | | zitronen |
| | | | | | -lachs-filets-mit- | mit | tiefkühlung > | | | | pfeffer |
| | | | | | zitronen-pfeffer- | zitronen- | fleisch, fisch & | | | | marinade |
| | | | | | marinade-2-stueck- | pfeffer- | meeresfrüchte > | | | | stück |
| | | | | | 250g-packung/p/ | . . . | packung | | | | packung |
| | | | | | 2020003331350 | packung | 250 g | | | | |
| | | | | | | 250 g | | | | | |

| | | clean | clean | |
|---|---|---|---|---|
| seller | clean | Bc | As Bc | feature |
| Id | AdditionalString | String | String | Vector |
| 41 | lebensmittel | tief | tief | [−0.07285787165164948, |
| | lachs filets | kühlungfleisch | kühlungfleisch | 0.0074628968723118305, |
| | mit zitronen | fisch | fisch | −0.07725667953491211, |
| | pfeffer | meeresfrüchte- | meeresfrüchte- | 0.032168369740247726, |
| | marinade | fisch | fisch | −0.02816387452185154, |
| | stueck | | lebensmittel | 0.000162382100825198] |
| | packung | | lachs filets | |
| | | | mit zitronen | |
| | | | pfeffer | |
| | | | marinade | |
| | | | stueck | |
| | | | packung | |

TABLE 8
(item of second entity after vectorization - feature vector)

| | | | | | | | | | | | clean |
|---|---|---|---|---|---|---|---|---|---|---|---|
| seller | item | | | brand | | feature | bread | unit | unit | bio- | Feature |
| Id | Id | L1 | TaxonomyCode | Name | additionalString | String | crumbs | Name | Measure | flag | String |
| 41 | 10547 | 412 | 9120 | | https: | lachs- | startseite > | g | 250 | 0 | lachs filets |
| | | | | | //www.inter.at/ | filets mit | produkte | | | | zitronen |
| | | | | | shop/lebensmittel/ | . . . | . . . | | | | pfeffer |
| | | | | | -lachs-filets-mit- | marinade | 2 stück | | | | marinade |
| | | | | | zitronen-pfeffer- | . . . | 250 g | | | | stück |
| | | | | | marinade-2-stueck- | packung | packung | | | | packung |
| | | | | | 250g-packung/p/ | 250 g | 250 g | | | | |
| | | | | | 2020003331350 | | | | | | |

| | | clean | clean | |
|---|---|---|---|---|
| seller | clean | Bc | As Bc | feature |
| Id | AdditionalString | String | String | Vector |
| 41 | lebens | tief | tief | [−0.07285787165164948, |
| | mittel | kühlungfleisch | kühlungfleisch | 0.0074628968723118305, |
| | lachs | fischmeeres | fisch . . . | −0.07725667953491211, |
| | filets | früchtefisch | filets mit | 0.000162382100825198] |
| | mit | | . . . | |
| | zitronen | | stueck | |
| | pfeffer | | packung | |
| | marinade | | | |
| | stueck | | | |
| | packung | | | |

At step 210 of the method of the present disclosure, the one or more hardware processors 104 build a first model and a second model using the set of code tagged items and the feature vector. The first model may also be referred to as ‘level 1 classifier model or L1 classifier model and may be interchangeably used herein. The second model may also be referred to as ‘taxonomy classifier model’ and may be interchangeably used herein. At step 212 of the method of the present disclosure, the one or more hardware processors 104 predict, by using the first model and the second model, (i) a first taxonomy level-based value, and (ii) the taxonomy code for each remaining item amongst the pre-processed dataset, respectively to obtain a third set of items. Below Table 9 depicts the first model and the second model built and prediction of (i) the first taxonomy level-based value, and (ii) the taxonomy code, respectively (e.g., refer columns 3 and 4).

TABLE 9

| | | | | | | | | | | | clean |
|---|---|---|---|---|---|---|---|---|---|---|---|
| seller | item | | Taxonomy | brand | | feature | bread | unit | unit | bio- | Feature |
| Id | Id | L1 | Code | Name | additionalString | String | crumbs | Name | Measure | flag | String |
| 4 | 345 | 412 | 30002820 | milfina | dairy käse & | emmentaler | NONE | g | 250 | 0 | emmentaler |
| | | | | | käseersatz- | gerieben | | | | | gerieben |
| | | | | | produkte | 250 g | | | | | |
| | | | | | käse | | | | | | |
| | | | | | gerieben & | | | | | | |
| | | | | | zerkleinert | | | | | | |
| 41 | 10547 | 412 | 9120 | | http://www.inter.at/ | lachs- | startseite > | g | 250 | 0 | lachs |
| | | | | | shop/lebensmittel/ | filets | produkte > | | | | filets |
| | | | | | -lachs-filets-mit- | mit | tiefkühlung | | | | zitronen |
| | | | | | zitronen-pfeffer- | zitronen- | . . . | | | | pfeffer |
| | | | | | marinade-2- | pfeffer- | 2 stück | | | | marinade |
| | | | | | stueck-250g- | marinade | 250 g | | | | stück |
| | | | | | packung/p/ | 2 stück | packung | | | | packung |
| | | | | | 2020003331350 | 250 g | 250 g | | | | |
| | | | | | | packung | | | | | |
| | | | | | | 250 g | | | | | |

| | clean | clean | clean | |
|---|---|---|---|---|
| seller | Additional | Bc | As Bc | feature |
| Id | String | String | String | Vector |
| 4 | dairy käse | dairy käse | dairy käse | [−0.002662169747054577, |
| | käseersatz- | käseersatz- | käseersatz- | 0.05370628461241722, |
| | produkte | produkte | produkte | 0.04652866721153259, |
| | gerieben | gerieben | gerieben | −0.07189878076314926, |
| | zerkleinert | zerkleinert | zerkleinert | 0.0400815941989421844] |
| | | | emmentaler | |
| 41 | lebensmittel | tief | tief | [−0.07285787165164948, |
| | lachs filets | kühlungfleisch | kühlungfleisch | 0.0074628968723118305, |
| | mit zitronen | fischmeeres | fischmeeres | −0.07725667953491211, |
| | pfeffer | früchtefisch | früchtefisch | 0.032168369740247726, |
| | marinade | | lebensmittel | −0.02816387452185154, |
| | stueck | | lachs filets | 0.000162382100825198] |
| | packung | | mit zitronen | |
| | | | pfeffer | |
| | | | marinade | |
| | | | stueck | |
| | | | packung | |

At step 214 of the method of the present disclosure, the one or more hardware processors 104 extract one or more features from the subset of items, and the third set of items. In feature extraction, one or more attributes associated with the subset of items, and the third set of items are concatenated to obtain a concatenated string (e.g., information from each column from below Table 10 is concatenated to obtain the concatenated string). Then keywords from a customized dictionary stored in database 108 are checked for its presence in the concatenated string for feature extraction. The matching keywords serve as the features that are extracted from the from the subset of items, and the third set of items. The customized database comprises various keywords pertaining to items information and is built with the help of domain expert or subject matter expert. The customized database may be periodically updated with new keywords based on the incoming data or requests for providing item recommendation. A predefined attribute value for each taxonomy code of the subset of items, and the third set of items is then obtained. A comparison of keywords between the subset of items, and the third set of items is then performed. The one or more features are then extracted from the subset of items, and the third set of items based on the comparison and the predefined attribute value. Below Table 10 depicts item details for which feature extraction is performed.

TABLE 10

| | product_ | GT | feature_ | brand_ | brand_ |
|---|---|---|---|---|---|
| item_id | name | Code | summary | name | type |
| 1 | Mayonnaise | 1568 | null | | manufacturer |
| | 50% Fett | | | | |
| | 0.5 L | | | | |
| Country_ | competitor_ | bread | product_ | | |
| of_origin | id | crumbs | details | Ingredients | allergens |
| NULL | 41 | Startseite > | -mit Freil | 49% | Eierundar- |
| | | Produkte > | and- | Sonnen- | ausge- |
| | | Vorratsschrank > | Eiern- | blumenöl, | wonnene |
| | | Grundnahrungs- | machtdas | Trinkwasser, | Erzeugnisse, |
| | | mittel > | Besteaus- | 4.6% EIG | Senf- |
| | | Ketchup & | lhren | ELB², | unddarausge- |
| | | Mayonnaise > | Gerichten! | Glukosesirup, | wonnene |
| | | Mayonnaise 50% | Entdecken | Weingeistessig, | Erz eugnisse |
| | | Fett 0.5 L | Sieunsere | Wei βweinessig, | |
| | | | Produkte- | modifizierte . . . | |
| | | | voller | allergene | |
| | | | Gesch- | Inhaltsstoffe. | |
| | | | mackund | | |
| | | | . . . | | |
| | | | Tube, im | | |
| | | | Beutel odor | | |
| | | | im Glas. | | |

Table 11 depicts the various attributes (penultimate column) and attribute value (last column) for taxonomy code 1658 by way of examples:

TABLE 11

| Taxonomy- | | brick | | | Attribute- |
|---|---|---|---|---|---|
| code | segmenttitle | code | bricktitle | attributetitle | Value_split_Ge |
| 1568 | Food/Beverage/ | 10006317 | Mayonnaise/ | Level of Fat | fett |
| | Tobacco | | Mayonnaise | Claim | |
| | | | Substitutes | | |
| | | | (Frozen) | | |
| 1568 | Food/Beverage/ | 10006317 | Mayonnaise/ | Level of Fat | frei |
| | Tobacco | | Mayonnaise | Claim | |
| | | | Substitutes | | |
| | | | (Frozen) | | |
| 1568 | Food/Beverage/ | 10006317 | Mayonnaise/ | Type of | creme |
| | Tobacco | | Mayonnaise | Mayonnaise/ | |
| | | | Substitutes | Mayonnaise | |
| | | | (Frozen) | Substitute | |
| . . . | . . . | . . . | . . . | . . . | . . . |
| 1568 | Food/Beverage/ | 10006319 | Mayonnaise/ | Type of | salat |
| | Tobacco | | Mayonnaise | Mayonnaise/ | |
| | | | Substitutes | Mayonnaise | |
| | | | (Shelf | Substitute | |
| | | | Stable) | | |

From the above Tables 10 and 11, a matching for the common keywords between the items is obtained by combining all attributes of the item(s) and a corpus is obtained as depicted in below Table 12.

TABLE 12

[ Mayonnaise 50% Fett 0.5 L,,Startseite > Produkte > Vorratsschrank >
Grundnahrungsmittel > Ketchup & Mayonnaise > Mayonnaise 50% Fett 0,5
L, - mit Freiland-Eiern macht das Beste aus Ihren Gerichten! Entdecken Sie
unsere Produkte - voller Geschmack und aus hochwertigen Zutaten
gemacht: Mit nur 50% Fettgehalt ist Fein Mayonnaise die leichte
Mayonnaise-Variante. Mit ihr lassen sich schmackhafte und sehr feine
Salatkreationen zaubern. Unsere feine Mayonnaise gibt es in der
praktischen Tube, im Beutel oder im Glas, 49% Sonnenblumenöl,
Trinkwasser, 4,6% EIGELB², Glukosesirup, Weingeistessig, Weißweinessig,
modifizierte Stärke, Zucker, Speisesalz, SENFSAAT, Gewürze, Zuckersirup,
Konservierungsstoff: Kaliumsorbat, Säuerungsmittel: Citronensäure,
Aromen, Farbstoff: Carotin. ²von Eiern aus Freilandhaltung. In
Großbuchstaben angegebene Zutaten enthalten allergene Inhaltsstoffe.,
Eier und daraus gewonnene Erzeugnisse, Senf und daraus gewonnene
Erzeugnisse]

Using matching keywords from the above Table 12, features are extracted as shown in below Table 13.

TABLE 13
{‘Level of Fat Claim’: [‘fett’, ‘frei’], ‘Type of Mayonnaise/Mayonnaise
Substitute’: [‘mayonnaise’, ‘salat’]}

At step 216 of the method of the present disclosure, the one or more hardware processors 104 process the taxonomy code, an associated taxonomy level, and a value associated with the one or more features in the plurality of natural language processing (NLP) engines to obtain a first set of recommended items. Since system 100 utilizes a series of NLP engines as depicted in FIG. 2, the outputs from the steps performed by each of these NLP engines (also referred to as artificial intelligence (AI) models) may be referred to as artificial intelligence (AI)-based output. In other words, the entire operations carried out by the NLP engines may be referred to as an AI pipeline to process the taxonomy code, an associated taxonomy level, and a value associated with the one or more features and intelligently obtain the first set of recommended items. The outputs from each NLP engine when put together form the first set of recommended items. For instance, the first set of recommended items may comprise a first subset of recommended items by a first NLP engine, a second subset of recommended items by a second NLP engine, a third subset of recommended items by a third NLP engine, and a fourth subset of recommended items from a fourth NLP engine. The step of processing by the first NLP engine (e.g., say similarity engine) amongst the plurality of NLP engines comprises filtering the second set of items for each item comprised in the first set of items based on the taxonomy code. A feature summary for the first set of items and the second set of items is then created based on the value of the one or more features. The feature summary is then converted into the feature vector of the first set of items and the second set of items. A cosine similarity score is computed for the first set of items and the second set of items based on the feature vector of the first set of items and the second set of items. Then the first NLP engine recommends at least a few items (e.g., the first subset of recommended items) amongst the first set of recommended items based on the cosine similarity score. The above step of processing to obtain the first set of recommended items based on the cosine similarity score by the first NLP engine (e.g., NLP engine 1) is better understood by way of following description. Table 14 depicts retailer's items.

TABLE 14

| | | | | | | sg_ | sg_sub- | | | |
|---|---|---|---|---|---|---|---|---|---|---|
| | | | | | sg_ | commodity- | commodity- | | | |
| retailer_ | product_ | Taxonomy_ | feature_ | country_ | category- | group- | group- | packaging_ | ingredient | allergen- |
| item_id | name | summary | summary | of_origin | description | description | description | description | statement | statement |
| 345 | Emmenr | 3002820 | {‘Consumer | NULL | Dairy | Kse & | Kse & | Schlauch- | MILCH, | NULL |
| | gerieben | | Lifestage’: | | | Kseersatz- | gerieben & | beutelfolie | Stärke, | |
| | 250 g | | [‘alle’], | | | produkte | zerkleinert | OPA/PE/ | Salz, | |
| | | | ‘Formation’: | | | | | 15/50 | Milch- | |
| | | | [‘block’, | | | | | | säure- | |
| | | | ‘gerieben’], | | | | | | bakterien- | |
| | | | . . . , | | | | | | kulturen, | |
| | | | ‘If in Sauce’: | | | | | | Propionsäu- | |
| | | | [‘NONE’]} | | | | | | rebakterien, | |
| | | | | | | | | | Lab | |

Similarly, Table 15 depicts the second set of items (competitor's items).

TABLE 15

| competitor_ | product_ | | feature_ | country_ |
|---|---|---|---|---|
| item_id | name | Taxonomycode | summary | or_origin |
| 7903 | Schärdinger | 30002820 | {‘Consumer | Österreich |
| | Bergkäse- | | Lifestage’: | Produkte > |
| | gerieben | | [‘alle’], | Kühlregal > |
| | 200 G | | ‘Formation’: | Käse > |
| | | | [‘block’, | Käse- |
| | | | ‘gerieben’], | gerieben > |
| | | | . . . , | Schärdinger |
| | | | ‘If in Sauce’: | Bergkase- |
| | | | [‘NONE’]} | gerieben |
| | | | | 200 G |
| 285177 | beda | 30002820 | {‘Consumer | Deutschland |
| | Graveganozum | | Lifestage’: | |
| | Reiben 150 g | | [‘alter’], | |
| | Packung | | Sauce’: | |
| | | | [‘NONE’]} | |
| 27557 | Schardinger | 30002820 | {‘Consumer | Österreich |
| | Emmentaler | | Lifestage’: | |
| | Gerieben | | [‘NONE’]} | |
| | 200 g Packung | | . . . | |
| | | | Sauce’: | |
| | | | [‘NONE’]} | |
| . . . | . . . | . . . | . . . | . . . |
| 601826 | Perfect | 30002820 | {‘Consumer | NULL |
| | Italiano Grated | | Lifestage’: | |
| | Cheese Perfect | | [‘NONE’]} | |
| | Bakes \\| 250 g | | . . . ‘If in | |
| | | | Sauce’: | |
| | | | [‘NONE’]} | |
| bread | product_ | | | |
| crumbs | description | pdp_url | allergens | ingredients |
| Startseite > | Derwürzig- | https:// | Milch- | MILCH, |
| | kräftige | www.inter.at/ | unddaraus- | Maisstärke, |
| | Bergkäse- | shop/Iebensmittel/ | gewonnene | Salz, Lab, |
| | geriebene- | schaerdinger- | Erzeugnisse | Käserei- |
| | ignet | bergkaese- | (inkl. | kulturen. |
| | sichideal- | gerieben/p/ | Lasktose) | In |
| | zumüber- | 2020005257945 | | Groβbusch- |
| | backen von | | | stabenange- |
| | herzhafte | | | gebene |
| | Speisen. | | | Zutatenenth- |
| | | | | altenaller- |
| | | | | gene |
| | | | | Inhaltsstoffe. |
| Alle | bedda | https://shop. | NULL | modifizierte |
| Kategorien > | Granvegano | billa.at/produkte/ | | Stärke, |
| Kühlwaren > | isteine | bedda-granvegano- | | Wasser, |
| Käse, | leckere | zum-reiben- | | Kokosöl |
| Aufstriche & | vegane . . . | 00596299 | | (24%), |
| Salate > | Wurzen von | | | Meersalz, |
| Parmesan & | frischen | | | Säureregulator: |
| Reibkäse | Salaten. | | | Calcium |
| | | | | citrate, Aroma, |
| | | | | Olivenxtrakt, |
| | | | | Reisprotein. |
| Alle | Esmussmal- | https://shop. | Enthält-Istim | Zutaten: |
| Kategorien > | wieder- | billa.at/produkte/ | Produkt | MILCH, |
| Kühlwaren > | schnellgehen? | schaerdinger- | enthalten | Maisstärke, |
| Käse, | . . . | emmentaler- | Milchund | Salz, Lab, |
| Aufstriche & | aberauch | gerieben- | Milcherz | Käserei- |
| Salate > | perfekt für | 00421626 | eugnisse | kulturen |
| Parmesan & | Pasta. | | | |
| Reibkäse | | | | |
| . . . | . . . | . . . | . . . | . . . |
| Dairy, Eggs & | Perfect | https://www.coles. | Contains | Cheese (Milk, |
| Fridge > | Italiano | com.au/product/ | Milk | Salt, Cultures, |
| Cheese > | Cheese Perfect | perfect-italiano- | | Enzyme), |
| Grated Cheese | Bakes Grated | grated-cheese- | | Anticaking |
| | 250 g | perfect-bakes- | | Agent (460), |
| | 3 Cheeses for | 250g-3274024 | | Preservative |
| | a crisp, golden | | | (200). |
| | crust | | | |

Using Tables 14 and 15, top ‘x’ items are recommended by the first engine as depicted in Table 16 below by way of examples:

TABLE 10

| retailer_ | competitor_ | retailer_item_ | competitor_ | | | competitor_ |
|---|---|---|---|---|---|---|
| item_id | item_id | name | item_name | aiscore | retailer_tcode | tcode |
| 345 | 10574 | Emmentaler | Emmentaler | 0.875531 | 30002820 | 30002820 |
| | | gerieben | gerieben | | | |
| | | 250 g | 250 G | | | |
| 345 | 10019 | Emmentaler | Pizza-Käse | 0.86802 | 30002820 | 30002820 |
| | | gerieben | gerieben. | | | |
| | | 250 g | leicht* 250 G | | | |
| 345 | 7952 | Emmentaler | Schärdinger | 0.860829 | 30002820 | 30002820 |
| | | gerieben | Gratinkäse | | | |
| | | 250 g | 200 G | | | |
| 345 | 8885 | Emmentaler | Cheddar rot | 0.860282 | 30002820 | 30002820 |
| | | gerieben | gerieben | | | |
| | | 250 g | 200 G | | | |

The cosine similarity score as computed by the first NLP engine is shown in the above Table 16 in the ‘aiscore column’ for specific item. In the present disclosure, the cosine similarity score is computed by way of following description. Given two n-dimensional vectors of attributes, A and B, the cosine similarity, cos (θ), is represented using a dot product and magnitude as:

$$\frac{{\sum }_{i = 1}^{n} AiBi}{\sqrt{{\sum }_{i = 1}^{n} {Ai}^{2}} \sqrt{{\sum }_{i = 1}^{n} {Bi}^{2}}}$$

where Ai and Bi are the ith components of vectors {A} and {B}, respectively. And cosine matching score CMS is in range [0,1].

Similarly, the step of processing by the second NLP engine (e.g., say taxonomy traversal engine) amongst the plurality of NLP engines is performed. More specifically, for each taxonomy code, the system 100 traverses through the associated taxonomy level for determining a match between an item of the first set of items and an item of the second set of items to obtain a set of level-based items. Further, one or more attributes of the set of level-based items are concatenated to obtain a set of concatenated attributes. The set of concatenated attributes are converted into the feature vector of the first set of items and the second set of items. Further, a cosine distance score between the first set of items and the second set of items based on the feature vector of the first set of items and the second set of items. A taxonomy based matching score is then computed based on the cosine distance score to obtain at least fewer items for recommendation (e.g., the second subset of recommended items). In other words, the first set of recommended items are obtained based on the taxonomy based matching score. The above step of processing to obtain the first set of recommended items based on the taxonomy based matching score by the second NLP engine (e.g., NLP engine 2) is better understood by way of following description. Table 17 depicts retailer's items by way of examples:

TABLE 17

| | | | | | | sg_ | sg_sub | | | |
|---|---|---|---|---|---|---|---|---|---|---|
| | | | | | sg_ | commodity- | commodity- | | | |
| retailer_ | product_ | Taxonomy | feature_ | country_ | category- | group- | group- | packaging_ | ingredient | allergen- |
| item_id | name | Code | summary | origin | description | description | description | description | statement | statement |
| 345 | Emment- | 30002820 | {‘Consumer | NULL | Dairy | Kse & | Ksegerieben & | Schlauch- | MILCH, | NULL |
| | alergerieben | | Lifestage’: | | | Kseersatz- | zerkleinert | beutelfolie | Stärke, | |
| | 250 g | | [‘alle’], . . . | | | produkte | | OPA/PE/ | Salz, | |
| | | | [‘NONE’]} | | | | | 15/50 | Milch- | |
| | | | | | | | | | säurebakte- | |
| | | | | | | | | | rienku | |
| | | | | | | | | | Ituren, | |
| | | | | | | | | | Propionsäure- | |
| | | | | | | | | | bakterien, Lab | |

Similarly, Table 18 depicts the second set of items (competitor's items).

TABLE 18

| competitor_ | product_ | Taxonomy | feature_ | country_ | bread | product_ | | | |
|---|---|---|---|---|---|---|---|---|---|
| item_id | name | code | summary | of_origin | crumbs | description | pdp_url | allergens | ingredients |
| 350694 | Mccain | 9043 | {‘If | NULL | Specials > | NULL | https://www.woolworths.com. | NULL | NULL |
| | Superfries | | Extruded’: . . . | | Low Price | | au/shop/productdetails/662933/ | | |
| | Straight | | Snack’: | | | | mccain-superfries-straight-cut | | |
| | Cut | | [‘chips’]} | | | | | | |
| 351426 | Dairyworks | 30002820 | {‘Consumer | NULL | Specials > | NULL | https://www.woolworths.com. | NULL | NULL |
| | Grated 3 | | Lifestage’: . . . | | Prices | | au/shop/productdetails/681853/ | | |
| | Cheese | | [‘NONE’]} | | Dropped | | dairyworks-grated-3-cheese- | | |
| | Mix | | | | | | mix | | |
| 350883 | Perfect | 30002820 | {‘Consumer | NULL | Dairy, | NULL | https://www.woolworths.com. | NULL | NULL |
| | Italiano | | Lifestage’: . . . | | Eggs & | | au/shop/productdetails/66922/ | | |
| | Grated | | [‘NONE’]} | | Fridge > | | perfect-italiano-grated- | | |
| | Mozzarella | | | | Cheese | | mozzarella | | |
| . . . | . . . | . . . | . . . | . . . | . . . | . . . | . . . | . . . | . . . |
| 350693 | Mccain | 9043 | {‘If | NULL | Specials > | NULL | https://www.woolworths.com. | NULL | NULL |
| | Superfries | | Extruded’: . . . | | Low | | au/shop/productdetails/662932/ | | |
| | Steak Cut | | Snack’: | | Price | | mccain-superfries-steak-cut | | |
| | | | [‘chips’]} | | | | | | |

Using Tables 17 and 18, taxonomy level-based items are obtained in Table 19 by way of examples:

TABLE 19

| | | | | | | | | | | Tcode | |
|---|---|---|---|---|---|---|---|---|---|---|---|
| | sub- | | | | | | | | Taxonomy | (taxonomy | Taxonomdy |
| category | category | L1 | L2 | L3 | L4 | L5 | L6 | L7 | List | code) | name |
| Food, | Food | 412 | 422 | 428 | 429 | 30002820 | 0 | 0 | [412, 422, | 30002820 | GRATED |
| Beverages & | Items | | | | | | | | 428, 429, | | |
| Tobacco | | | | | | | | | 30002820, | | |
| | | | | | | | | | 0, 0] | | |

Attributes from the above Table 19 are then concatenated and converted into feature vector for the first entity and the second entity as depicted in Tables 20 and 21, respectively. More specifically, Table 20 depicts 5 feature vector of the first set of items pertaining to the first entity, and Table 21 depicts feature vector of the second set of items pertaining to the second entity.

TABLE 20

| seller | item | | Taxonomy | brand | additional | feature | bread |
|---|---|---|---|---|---|---|---|
| Id | Id | L1 | Code | Name | String | String | crumbs |
| 4 | 345 | 412 | 30002820 | milfina | dairy käse & | emmentaler | NONE |
| | | | | | käseersatz- | gerieben | |
| | | | | | produkte | 250 g | |
| | | | | | käse . . . & | | |
| | | | | | zerkleinert | | |
| | | | clean | clean | clean | clean | |
| unit | unit | bio_ | Feature | Additional | Bc | As Bc | feature |
| Name | Measure | flag | String | String | String | String | Vector |
| g | 250 | 0 | emmentaler | dairy | dairy | dairy | [−0.00- |
| | | | gerieben | käseer- | käse | käse | 266216- |
| | | | | satzprodukte | käseer- | käseer- | 974705- |
| | | | | gerieben | satz- | satz- | 4577, . . . |
| | | | | zerkleinert | produkte | produkte . . . | 0.04081- |
| | | | | | gerieben | emmentaler | 594198- |
| | | | | | zerkleinert | | 9421844] |

TABLE 21

| seller | item | | Taxonomy | brand | additional | feature | bread |
|---|---|---|---|---|---|---|---|
| Id | Id | L1 | Code | Name | String | String | crumbs |
| 41 | 10547 | 412 | 9120 | | https://www.inter. | lachs- | starts |
| | | | | | at/shop/lebensmittel/- | filets | eite > |
| | | | | | lachs-filets-mit- | mit | produkte > |
| | | | | | zitronen-pfeffer- | zitronen- | tiefkühlung > |
| | | | | | marinade-2-stueck- | pfeffer- . . . | fleisch, . . . |
| | | | | | 250 g-packung/p/ | 250 g | 250 g |
| | | | | | 2020003331350 | | |
| | | | | | | clean | |
| | | | | | clean | As | |
| unit | unit | bio_ | clean | clean | Bc | Bc | feature |
| Name | Measure | flag | Feature | Additional | String | String | Vector |
| g | 250 | 0 | lachs | lebens | tiefkühlung- | tiefkühlung- | [−0.07285- |
| | | | filets | mittel | fleisch | fleisch | 7877165- |
| | | | zitronen | lachs | fischmere | fischmere | 164948, . . . , |
| | | | pfeffer | filets | sfrüchte | sfrüchte | − . . . |
| | | | marinade | mitzitronen | fisch | fisch . . . | 0.02816- |
| | | | stuck | pfeffer | | stueck | 387452185- |
| | | | packung | marinade | | packung | 154, 0.00016- |
| | | | | stueck | | | 238210082- |
| | | | | packung | | | 5198] |

Using the feature vectors from Table 20 and Table 21, a cosine distance score between the first set of items and the second set of items is computed based on which a taxonomy based matching score is computed. The taxonomy based matching score is computed by way of following description. The item1 and item2 are represented as vectors Ai and Bi respectively. The matching score TMS is derived as follows:

$$( 1 - \frac{Ai \cdot Bi}{{‖ Ai ‖}_{2} {‖ B ‖}_{2}}$$

Then, at least fewer items amongst the first set of recommended items are obtained based on the taxonomy based matching score. The recommended items with taxonomy based matching score (e.g., refer 3^{rd} column in below Table 22) are depicted in Table 22 below:

TABLE 22

| | | Aiscore | | |
|---|---|---|---|---|
| | | (taxonomy | | |
| | | based | | |
| retailer_{—} | competitor_{—} | matching | retailer_{—} | competitor_{—} |
| item_name | item_name | score) | tcode | tcode |
| Emmentaler | Emmentaler | 0.875331 | 30002820 | 30002820 |
| gerieben 250 g | gerieben 250 G | | | |
| Emmentaler | Fallini Käse | 0.748203 | 30002820 | 30002820 |
| gerieben 250 g | gerieben 40 G | | | |
| Emmentaler | Bergbauern- | 0.737946 | 30002820 | 30002837 |
| gerieben 250 g | Emmentaler in | | | |
| | Scheiben 200 G | | | |
| Emmentaler | bedda veganer | 0.710421 | 30002820 | 9113 |
| gerieben 250 g | Käseersatz | | | |

Similarly, the step of processing by the third NLP engine (e.g., say semantic engine) amongst the plurality of NLP engines is performed. More specifically, an index of the second set of items is created. A semantic match for a query item associated with the first set of items is identified in the index of the second set of items. A semantic matching score is then computed based on the semantic match. In other words, semantic matching for the given retailer item name is searched in the index of the competitor items, and the Euclidean distance is computed between the query item and the item in the index which forms the semantic matching score.

The above step of computing the semantic matching score and obtaining at least fewer items (e.g., the third subset of recommended items) amongst the first set of recommended items based on the semantic matching score is better understood by way of following description. Table 23 depicts the first set of items pertaining to the first entity (e.g., the retailer items).

TABLE 23

| | | | | | | sg_ | sg_sub | | | |
|---|---|---|---|---|---|---|---|---|---|---|
| | | | | | sg_ | commodity | commodity | | | |
| retailer_ | product_ | Taxonomy | feature_ | country_ | category | group | group | packaging_ | ingredient | allergen |
| item_id | name | Code | summary | of_origin | description | description | description | description | statement | statement |
| 345 | Emmentaler | 30002820 | {‘Consumer | NULL | Dairy | kse & | Kse | Schlauch | MILCH, | NULL |
| | gerieben | | Lifestage’: | | | Kseersatz- | gerieben & | beutelfolie | Stärke, | |
| | 250 g | | [‘alle’], . . . | | | produkte | zerkleinert | OPA/PE/ | Milch | |
| | | | [‘NONE’]} | | | | | 15/50 | säurebakte- | |
| | | | | | | | | | rienku | |
| | | | | | | | | | Ituren, | |
| | | | | | | | | | Propionsäure- | |
| | | | | | | | | | bakterien, Lab | |

For the sake of brevity, Table for the second set of items pertaining to the second entity (e.g., the competitor items) is not shown.

However, using both the Table 23 and competitor items (not shown), the semantic matching score is computed. First, Faiss IndexFlatL2 index is run, wherein this index is built for a set of items which need to be searched. This index is referred to as the query item. The Euclidean distance (in Euclidean space—the vectors of item1 and item2 are denoted by qi and pi) between the query item and the item in the index which forms the score is derived as follows.

$$\sqrt{{\sum }_{i = 1}^{n} {( qi - pi )}^{2}}$$

Semantic matching based score € [0,1]. Below Table 24 depicts at least fewer items amongst the first set of recommended items that are obtained based on the semantic matching score. The recommended items with semantic matching score (e.g., refer 5^{th} column in below Table 24) are depicted in Table 24 below:

TABLE 24

| | | | | Aiscore | | |
|---|---|---|---|---|---|---|
| | | retailer_ | | (semantic | | |
| retailer_ | competitor_ | item_ | competitior_ | matching | retailer_ | competitor_ |
| item_id | item_id | name | item_name | score) | tcode | tcode |
| 345 | 3872 | Emmentaler | Salzburg | 0.7967 | 30002820 | 30001237 |
| | | gerieben | Milch | | | |
| | | 250 g | Emmentaler | | | |
| | | | Scheiben 1 KG | | | |
| 345 | 5011 | Emmentaler | Emmentaler in | 0.7967 | 30002820 | 30001237 |
| | | gerieben | Scheiben 1 KG | | | |
| | | 250 g | | | | |
| 345 | 9193 | Emmentaler | Philadelphia | 0.755447 | 30002820 | 5785 |
| | | gerieben | mit Milka | | | |
| | | 250 g | 175 G | | | |
| 345 | 8404 | Emmentaler | NÖM NÖM | 0.754907 | 30002820 | 5785 |
| | | gerieben | Cottage | | | |
| | | 250 g | Cheese natur | | | |
| | | | 200 G | | | |
| 345 | 10574 | Emmentaler | Emmentaler | 0.875331 | 30002820 | 30002820 |
| | | gerieben | gerieben | | | |
| | | 250 g | 250 G | | | |

Similarly, the step of processing by the fourth NLP engine (e.g., say string match engine) amongst the plurality of NLP engines is performed. More specifically, a comparison of a name associated with each item amongst the first of items with each item amongst the second of items is performed and a string matching score is computed based on the comparison.

For the sake of brevity items of first entity and the second entity are not shown. However, in the present disclosure, the system 100 considered Table 23 which consisted of first set of items of the first entity (e.g., retailer's items) for string matching score computation. Similarly, the second set of items of the second entity (e.g., the competitor's item) are not shown but can be realized in practice. Item names of given retailer item are matched with competitor item, wherein CC=length of the longest common character set among the two item strings. This can happen to many substrings say n, wherein higher the string matching score (SMS) value the greater is the likelihood of similarity between the items, wherein string matching score SMS [0,1]. For instance, given two item strings item Retailer (item 1) and item Competitor (item 2) the matching score that denotes the extent of similarity had been derived using the following formula:

$$SMS = ( {2}^{*} {\sum }_{i = 1}^{n} CC ) / ( \vert item 1 \vert + \vert item 2 \vert )$$

where SMS ε[0,1]

Based on the above score computation, at least fewer items (e.g., the fourth subset of recommended items) amongst the first set of recommended items that are obtained based on the string matching score. The recommended items with string matching score (e.g., refer 5th column in below Table 25) are depicted in Table 25 below:

TABLE 25

| | | | | Aiscore | | |
|---|---|---|---|---|---|---|
| | | retailer_ | | (semantic | | |
| retailer_ | competitor_ | item_ | competitior_ | matching | retailer_ | competitor_ |
| item_id | item_id | name | item_name | score) | tcode | tcode |
| 345 | 10574 | Emmentaler | Emmentaler | 0.875331 | 30002820 | 30002820 |
| | | gerieben | gerieben | | | |
| | | 250 g | 250 G | | | |
| 345 | 240055 | Emmentaler | Emmentaler | 0.842105 | 30002820 | 30001237 |
| | | gerieben | in Scheiben | | | |
| | | 250 g | 400 G | | | |
| 345 | 3872 | Emmentaler | SalzburgMilch | 0.7967 | 30002820 | 30001237 |
| | | gerieben | Emmentaler | | | |
| | | 250 g | Scheiben 1 KG | | | |
| 345 | 5011 | Emmentaler | Emmentaler | 0.7967 | 30002820 | 30001237 |
| | | gerieben | in Scheiben | | | |
| | | 250 g | 1 KG | | | |
| 345 | 7608 | Emmentaler | Schärdinger | 0.734694 | 30002820 | 30001237 |
| | | gerieben | Emmentaler | | | |
| | | 250 g | geräuchert in | | | |
| | | | Scheiben 150 g | | | |
| | | | 150 G | | | |

Once the first set of recommended items are obtained as shown above, one or more rules on the first set of recommended items to obtain a fourth set of items at step 218. Each rule is associated with at least one NLP engine amongst the plurality of NLP engines. Below Table 26 depicts illustrative rules applied on the first set of recommended items to obtain the fourth set of items.

TABLE 26

| Rule | Rule description |
|---|---|
| 1 | Country of origin should match |
| 2 | Ingredient such as Fat content, |
| | Sugar, Salt should match |
| 3 | Allergen value - Gluten free should |
| | match |
| 4 | Organic product should be compared |
| | with only Organic products |
| | Manufacturer brand should be |
| | compared with Manufacturer brand |
| 5 | e.g. Coca cola with coca cola |
| 6 | Grammages content should be |
| | comparable with (+/−) 50% range e.g. |
| | 500 gm product can be compared |
| | with max. 750 gm or 250 gm for |
| | potential match |

It is to be understood by a person having ordinary skill in the art or person skilled in the art that the above rules are representative and such rules shall not be construed as limiting the scope of the present disclosure. Further, at step 220 of the method of the present disclosure, the one or more hardware processors 104 group one or more items from the fourth set of items into one or more categories, and at least a subset of items amongst the fourth set of items are recommended to obtain a second set of recommended items at step 222. The second set of recommended items is based on a weightage associated to each of the plurality of NLP engines, in one embodiment of the present disclosure.

Table 27 depicts the second set of recommended items that are categorized into various categories by the NLP engines.

TABLE 27

| retailer | competitor_ | retailer_ | competitor_ | retailer_ | competitor_ | |
|---|---|---|---|---|---|---|
| item_id | item_id | item_name | item_name | tcode | tcode | bucket |
| 345 | 10574 | Emmen | Emmentaler | 30002820 | 30002820 | 1 |
| | | gerieben | gerieben | | | |
| | | 250 g | 250 G | | | |
| 345 | 5011 | Emmen | Emmentaler | 30002820 | 30001237 | 3 |
| | | gerieben | in Scheiben | | | |
| | | 250 g | 1 KG | | | |
| 345 | 10019 | Emmen | Pizza-Käse | 30002820 | 30002820 | 4 |
| | | gerieben | gerieben. | | | |
| | | 250 g | leicht* | | | |
| | | | 250 G | | | |
| 345 | 7952 | Emmen | Schärdinger | 30002820 | 30002820 | 4 |
| | | gerieben | Gratinkäse | | | |
| | | 250 g | 200 G | | | |
| 345 | 8885 | Emmen | Cheddar rot | 30002820 | 30002820 | 4 |
| | | gerieben | gerieben | | | |
| | | 250 g | 200 G | | | |
| 345 | 240055 | Emmen | Emmentaler | 30002820 | 30001237 | 4 |
| | | gerieben | in Scheiben | | | |
| | | 250 g | 400 G | | | |
| 345 | 7953 | Emmen | Schärdinger | 30002820 | 30002820 | 4 |
| | | gerieben | Spätzlekäse | | | |
| | | 250 g | 200 G | | | |
| 345 | 3872 | Emmen | Salzburg | 30002820 | 30001237 | 3 |
| | | gerieben | Milch | | | |
| | | 250 g | Emmentaler | | | |
| | | | Scheiben 1 | | | |
| | | | KG | | | |

In the above table 27, the bucketing is referred to as grouping of items into various categories. For instance, items are grouped into a first category based on an item comprised in the first set of recommended items that is recommended by a first combination of NLP engines. In other words, match items which are recommended by all engines (e.g., (e.g., say first engine, second engine, third engine, and fourth engine) are put into bucket 1. Similarly, items are grouped into a second category based on an item comprised in the first set of recommended items that is recommended by a second combination of NLP engines. In other words, match items which are recommended by any 3 NLP engines (e.g., say (i) first engine, second engine, and fourth engine, or (ii) first engine, second engine, and third engine, or (ii) second engine, third engine, and fourth engine, or iv) first engine, third engine, and fourth engine) are put into bucket 2. Further, items are grouped into a third category based on an item comprised in the first set of recommended items that is recommended by a third combination of NLP engines. In other words, matched items which are recommended by any 2 engines (e.g., (i) first engine and second engine, or (ii) first engine and third engine, or (iii) first engine and fourth engine, or (iv) second engine and third engine, or (v) second engine and fourth engine, or (vi) third engine and fourth engine) are put into bucket 3. Furthermore, items are grouped into a fourth category based on an item comprised in the first set of recommended items that is recommended by a NLP engine. In other words, matched items which are recommended by one engine (e.g., only first engine, or only second engine, or only third engine, or only fourth engine) are put into bucket 4. Bucket 4 contains the non-overlapping matches, thus contains the highest number of recommendations. To limit the recommendation to count of 3, the system 100 considers bucket 4 by giving weightage to String, Taxonomy, Semantic and Similarity in sequence. In other words, the weightage associated to each of the plurality of NLP engines is determined based on a match of an item comprised in the fourth set of items with an associated item amongst the second set of items and accordingly the second set of recommended items are obtained in specific order. Further, the weightage of each of the plurality of NLP engines are updated based on a comparison of (i) one or more items amongst the second set of recommended items, and (ii) a fifth set of items. For instance, the second set of recommended items are validated by a domain expert or subject matter expert. In other words, updated weights are obtained based on a small set of item matches after comparing them with human validated matches. The second set of recommended items are then sorted based on the updated weightage. In other words, the matches are sorted in a specific order (e.g., say in descending order) based on the updated weights. The higher the weightage for the NLP engine(s), it would be getting higher priority for that match.

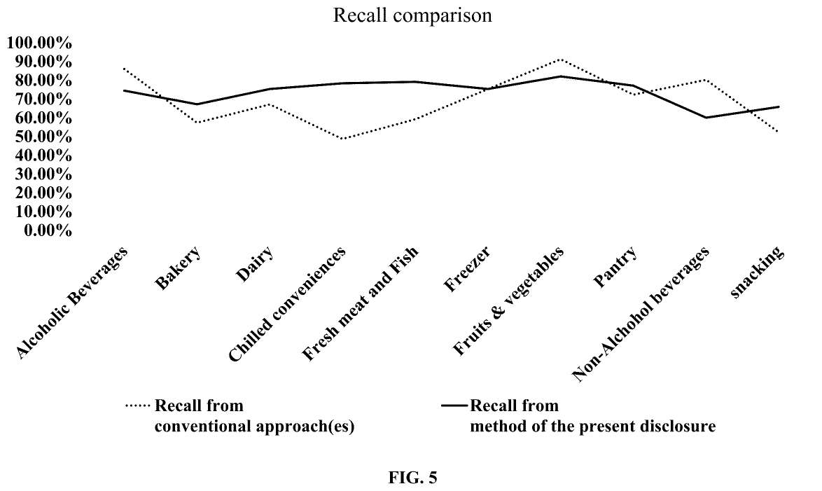

FIG. 5, with reference to FIGS. 1 through 4, depicts a graphical representation of recalled percentage against labelled matches of items, in accordance with an embodiment of the present disclosure. As depicted in FIG. 5, with the method of the present disclosure, the accuracy has increased by an average of 4.5% on all categories as compared to conventional approach.

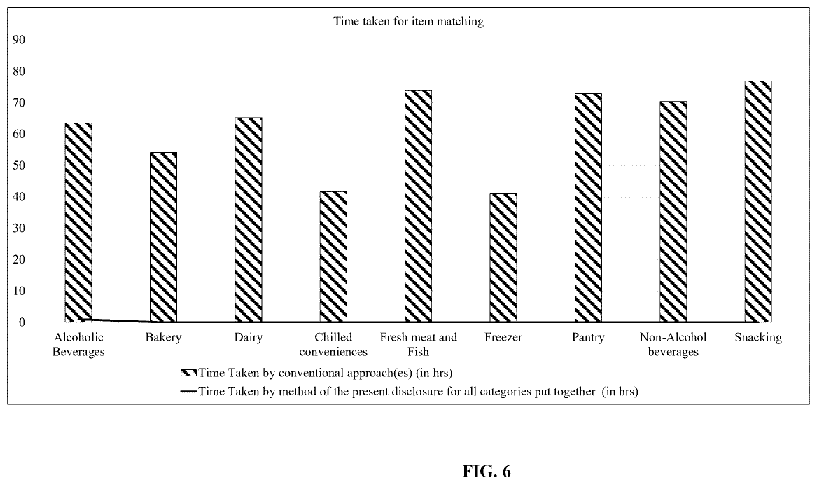

FIG. 6, with reference to FIGS. 1 through 5, depicts a graphical representation illustrating time taken for item matching (throughput) by the method of the present disclosure and conventional approach(es), in accordance with an embodiment of the present disclosure. With conventional approach, it used to take about 559.68 hours to complete the process (represented by the bar graph), whereas with method of the present disclosure the pipeline takes 3.5 hours to process and give recommendation for all categories (represented by the line graph), there by substantially reducing the time taken. Below Table 28 depicts various values illustrated in the graphical representation of FIG. 6.

TABLE 28

| | | Time Taken by | Time Taken by |
|---|---|---|---|
| | | conventional | method of the |
| | Item | approaches (in | present disclosure |
| Category name | Count | hrs) | (in hrs) |
| Alcoholic Beverages | 762 | 63.50 | 3.50 |
| Bakery | 650 | 54.17 | |
| Dairy | 783 | 65.25 | |
| Chilled conveniences | 500 | 41.67 | |
| Fresh meat and Fish | 886 | 73.83 | |
| Freezer | 492 | 41.00 | |
| Pantry | 875 | 72.92 | |
| Non-Alcohol beverages | 845 | 70.42 | |
| snacking | 923 | 76.92 | |
| Total time taken | 6716 | 559.68 | 3.50 |

The written description describes the subject matter herein to enable any person skilled in the art to make and use the embodiments. The scope of the subject matter embodiments is defined by the claims and May include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, comprising:
receiving, via one or more hardware processors, information comprising a first set of items pertaining to a first entity, and a second set of items pertaining to a second entity;
pre-processing, via the one or more hardware processors, the information comprising the first set of items pertaining to the first entity and the second set of items pertaining to the second entity to obtain a pre-processed dataset;
obtaining, via the one or more hardware processors, a taxonomy code to at least a subset of items amongst the pre-processed dataset to obtain a set of code tagged items, wherein each code tagged item amongst the set of code tagged items is associated with one or more attributes;
converting, by using a sentence encoder via the one or more hardware processors, the one or more attributes comprised in the set of code tagged items into a feature vector, wherein the feature vector is associated with the first set of items and the second set of items;
building, via the one or more hardware processors, a first model and a second model using the set of code tagged items and the feature vector;
predicting, by using the first model and the second model via the one or more hardware processors, (i) a first taxonomy level-based value, and (ii) the taxonomy code for each remaining item amongst the pre-processed dataset, respectively to obtain a third set of items;
extracting, via the one or more hardware processors, one or more features from the subset of items, and the third set of items;
processing, via the one or more hardware processors, the taxonomy code, an associated taxonomy level, and a value associated with the one or more features in a plurality of natural language processing (NLP) engines to obtain a first set of recommended items;
applying, via the one more hardware processors, one or more rules on the first set of recommended items to obtain a fourth set of items, wherein each rule is associated with at least one NLP engine amongst the plurality of NLP engines;
grouping, via the one more hardware processors, one or more items from the fourth set of items into one or more categories; and
recommending, via the one or more hardware processors, at least a subset of items amongst the fourth set of items to obtain a second set of recommended items, wherein the second set of recommended items is based on a weightage associated to each of the plurality of NLP engines.

2. The processor implemented method of claim 1, wherein the step of obtaining the taxonomy code is based on at least one of an associated item category and an associated item sub-category.

3. The processor implemented method of claim 1, wherein the step of extracting the one or more features from the subset of items, and the third set of items comprises:
concatenating one or more attributes associated with the subset of items, and the third set of items;
obtaining a predefined attribute value for each taxonomy code of the subset of items, and the third set of items;
performing a comparison of keywords between the subset of items, and the third set of items; and
extracting the one or more features from the subset of items, and the third set of items based on the comparison and the predefined attribute value.

4. The processor implemented method of claim 1, wherein the step of processing by a first NLP engine amongst the plurality of NLP engines comprises:
filtering the second set of items for each item comprised in the first set of items based on the taxonomy code;
creating a feature summary for the first set of items and the second set of items based on the value of the one or more features;
converting the feature summary into the feature vector of the first set of items and the second set of items;
computing a cosine similarity score for the first set of items and the second set of items based on the feature vector of the first set of items and the second set of items; and
obtaining the first set of recommended items based on the cosine similarity score,
wherein the step of processing by a second NLP engine amongst the plurality of NLP engines comprises:
for each taxonomy code:
traversing through the associated taxonomy level for determining a match between an item of the first set of items and an item of the second set of items to obtain a set of level-based items;
concatenating one or more attributes of the set of level-based items to obtain a set of concatenated attributes;
converting the set of concatenated attributes into the feature vector of the first set of items and the second set of items;
computing a cosine distance score between the first set of items and the second set of items based on the feature vector of the first set of items and the second set of items;
computing a taxonomy based matching score based on the cosine distance score; and
obtaining the first set of recommended items based on the taxonomy based matching score,
wherein the step of processing by a third NLP engine amongst the plurality of NLP engines comprises:
creating an index of the second set of items;
identifying a semantic match for a query item associated with the first set of items in the index of the second set of items;
computing a semantic matching score based on the semantic match; and
obtaining the first set of recommended items based on the semantic matching score; and
wherein the step of processing by a fourth NLP engine amongst the plurality of NLP engines comprises:
performing a comparison of a name associated with each item amongst the first of items with each item amongst the second of items;
computing a string matching score based on the comparison; and
obtaining the first set of recommended items based on the string matching score.

5. The processor implemented method of claim 1, wherein the step of grouping, comprises:
grouping one or more items into a first category based on an item comprised in the first set of recommended items that is recommended by a first combination of NLP engines;
grouping one or more items into a second category based on an item comprised in the first set of recommended items that is recommended by a second combination of NLP engines;
grouping one or more items into a third category based on an item comprised in the first set of recommended items that is recommended by a third combination of NLP engines; and
grouping one or more items into a fourth category based on an item comprised in the first set of recommended items that is recommended by a NLP engine.

6. The processor implemented method of claim 1, wherein the weightage associated to each of the plurality of NLP engines is determined based on a match of an item comprised in the fourth set of items with an associated item amongst the second set of items.

7. The processor implemented method of claim 1, further comprising:
updating the weightage of each of the plurality of NLP engines based on a comparison of (i) one or more items amongst the second set of recommended items, and (ii) a fifth set of items; and
sorting the second set of recommended items based on the updated weightage.

8. A system, comprising:
a memory storing instructions;
one or more communication interfaces; and
one or more hardware processors coupled to the memory via the one or more communication interfaces, wherein the one or more hardware processors are configured by the instructions to:
receive information comprising a first set of items pertaining to a first entity, and a second set of items pertaining to a second entity;
pre-process the information comprising the first set of items pertaining to the first entity and the second set of items pertaining to the second entity to obtain a pre-processed dataset;
obtain a taxonomy code to at least a subset of items amongst the pre-processed dataset to obtain a set of code tagged items, wherein each code tagged item amongst the set of code tagged items is associated with one or more attributes;
convert, by using a sentence encoder, the one or more attributes comprised in the set of code tagged items into a feature vector, wherein the feature vector is associated with the first set of items and the second set of items;
build a first model and a second model using the set of code tagged items and the feature vector;
predict, by using the first model and the second model, (i) a first taxonomy level-based value, and (ii) the taxonomy code for each remaining item amongst the pre-processed dataset, respectively to obtain a third set of items;
extract one or more features from the subset of items, and the third set of items;
process the taxonomy code, an associated taxonomy level, and a value associated with the one or more features in a plurality of natural language processing (NLP) engines to obtain a first set of recommended items;
apply one or more rules on the first set of recommended items to obtain a fourth set of items, wherein each rule is associated with at least one NLP engine amongst the plurality of NLP engines;
group one or more items from the fourth set of items into one or more categories; and
recommend at least a subset of items amongst the fourth set of items to obtain a second set of recommended items, wherein the second set of recommended items is based on a weightage associated to each of the plurality of NLP engines.

9. The system of claim 8, wherein the taxonomy code is based on at least one of an associated item category and an associated item sub-category, and wherein the weightage associated to each of the plurality of NLP engines is determined based on a match of an item comprised in the fourth set of items with an associated item amongst the second set of items.

10. The system of claim 8, wherein the one or more features are extracted from the subset of items, and the third set of items by
concatenating one or more attributes associated with the subset of items, and the third set of items;
obtaining a predefined attribute value for each taxonomy code of the subset of items, and the third set of items;
performing a comparison of keywords between the subset of items, and the third set of items; and
extracting the one or more features from the subset of items, and the third set of items based on the comparison and the predefined attribute value.

11. The system of claim 8, wherein a first NLP engine amongst the plurality of NLP engines processes the taxonomy code, the associated taxonomy level, and the value associated with the one or more features by:
filtering the second set of items for each item comprised in the first set of items based on the taxonomy code;
creating a feature summary for the first set of items and the second set of items based on the value of the one or more features;
converting the feature summary into the feature vector of the first set of items and the second set of items;
computing a cosine similarity score for the first set of items and the second set of items based on the feature vector of the first set of items and the second set of items; and
obtaining the first set of recommended items based on the cosine similarity score,
wherein a second NLP engine amongst the plurality of NLP engines processes the taxonomy code, the associated taxonomy level, and the value associated with the one or more features by:
for each taxonomy code:
traversing through the associated taxonomy level for determining a match between an item of the first set of items and an item of the second set of items to obtain a set of level-based items;
concatenating one or more attributes of the set of level-based items to obtain a set of concatenated attributes;
converting the set of concatenated attributes into the feature vector of the first set of items and the second set of items;
computing a cosine distance score between the first set of items and the second set of items based on the feature vector of the first set of items and the second set of items;
computing a taxonomy based matching score based on the cosine distance score; and
obtaining the first set of recommended items based on the taxonomy based matching score,
wherein a third NLP engine amongst the plurality of NLP engines processes the taxonomy code, the associated taxonomy level, and the value associated with the one or more features by:
creating an index of the second set of items;
identifying a semantic match for a query item associated with the first set of items in the index of the second set of items;
computing a semantic matching score based on the semantic match; and
obtaining the first set of recommended items based on the semantic matching score, and
wherein a fourth NLP engine amongst the plurality of NLP engines processes the taxonomy code, the associated taxonomy level, and the value associated with the one or more features by:
performing a comparison of a name associated with each item amongst the first of items with each item amongst the second of items;
computing a string matching score based on the comparison; and
obtaining the first set of recommended items based on the string matching score.

12. The system of claim 8, wherein the one or more categories are obtained:
grouping one or more items into a first category based on an item comprised in the first set of recommended items that is recommended by a first combination of NLP engines;
grouping one or more items into a second category based on an item comprised in the first set of recommended items that is recommended by a second combination of NLP engines;
grouping one or more items into a third category based on an item comprised in the first set of recommended items that is recommended by a third combination of NLP engines; and
grouping one or more items into a fourth category based on an item comprised in the first set of recommended items that is recommended by a NLP engine.

13. The system of 8, wherein the weightage associated to each of the plurality of NLP engines is determined based on a match of an item comprised in the fourth set of items with an associated item amongst the second set of items.

14. The system of claim 8, wherein the one or more hardware processors are further configured by the instructions to
update the weightage of each of the plurality of NLP engines based on a comparison of (i) one or more items amongst the second set of recommended items, and (ii) a fifth set of items; and
sort the second set of recommended items based on the updated weightage.

15. One or more non-transitory machine-readable information storage mediums comprising one or more instructions which when executed by one or more hardware processors cause:
receiving information comprising a first set of items pertaining to a first entity, and a second set of items pertaining to a second entity;
pre-processing the information comprising the first set of items pertaining to the first entity and the second set of items pertaining to the second entity to obtain a pre-processed dataset;
obtaining a taxonomy code to at least a subset of items amongst the pre-processed dataset to obtain a set of code tagged items, wherein each code tagged item amongst the set of code tagged items is associated with one or more attributes;
converting, by using a sentence encoder, the one or more attributes comprised in the set of code tagged items into a feature vector, wherein the feature vector is associated with the first set of items and the second set of items;
building a first model and a second model using the set of code tagged items and the feature vector;
predicting, by using the first model and the second model, (i) a first taxonomy level-based value, and (ii) the taxonomy code for each remaining item amongst the pre-processed dataset, respectively to obtain a third set of items;
extracting one or more features from the subset of items, and the third set of items;
processing the taxonomy code, an associated taxonomy level, and a value associated with the one or more features in a plurality of natural language processing (NLP) engines to obtain a first set of recommended items;
applying one or more rules on the first set of recommended items to obtain a fourth set of items, wherein each rule is associated with at least one NLP engine amongst the plurality of NLP engines;
grouping one or more items from the fourth set of items into one or more categories; and
recommending at least a subset of items amongst the fourth set of items to obtain a second set of recommended items, wherein the second set of recommended items is based on a weightage associated to each of the plurality of NLP engines.

16. The one or more non-transitory machine-readable information storage mediums of claim 15, wherein the step of obtaining the taxonomy code is based on at least one of an associated item category and an associated item sub-category, and
wherein the weightage associated to each of the plurality of NLP engines is determined based on a match of an item comprised in the fourth set of items with an associated item amongst the second set of items.

17. The one or more non-transitory machine-readable information storage mediums of claim 15, wherein the step of extracting the one or more features from the subset of items, and the third set of items comprises:
concatenating one or more attributes associated with the subset of items, and the third set of items;
obtaining a predefined attribute value for each taxonomy code of the subset of items, and the third set of items;
performing a comparison of keywords between the subset of items, and the third set of items; and
extracting the one or more features from the subset of items, and the third set of items based on the comparison and the predefined attribute value.

18. The one or more non-transitory machine-readable information storage mediums of claim 15, wherein the step of processing by a first NLP engine amongst the plurality of NLP engines comprises:
filtering the second set of items for each item comprised in the first set of items based on the taxonomy code;
creating a feature summary for the first set of items and the second set of items based on the value of the one or more features;
converting the feature summary into the feature vector of the first set of items and the second set of items;
computing a cosine similarity score for the first set of items and the second set of items based on the feature vector of the first set of items and the second set of items; and
obtaining the first set of recommended items based on the cosine similarity score,
wherein the step of processing by a second NLP engine amongst the plurality of NLP engines comprises:
for each taxonomy code:
traversing through the associated taxonomy level for determining a match between an item of the first set of items and an item of the second set of items to obtain a set of level-based items;
concatenating one or more attributes of the set of level-based items to obtain a set of concatenated attributes;
converting the set of concatenated attributes into the feature vector of the first set of items and the second set of items;
computing a cosine distance score between the first set of items and the second set of items based on the feature vector of the first set of items and the second set of items;
computing a taxonomy based matching score based on the cosine distance score; and
obtaining the first set of recommended items based on the taxonomy based matching score,
wherein the step of processing by a third NLP engine amongst the plurality of NLP engines comprises:
creating an index of the second set of items;
identifying a semantic match for a query item associated with the first set of items in the index of the second set of items;
computing a semantic matching score based on the semantic match; and
obtaining the first set of recommended items based on the semantic matching score, and
wherein the step of processing by a fourth NLP engine amongst the plurality of NLP engines comprises:
performing a comparison of a name associated with each item amongst the first of items with each item amongst the second of items;
computing a string matching score based on the comparison; and
obtaining the first set of recommended items based on the string matching score.

19. The one or more non-transitory machine-readable information storage mediums of claim 15, wherein the step of grouping comprises:
grouping one or more items into a first category based on an item comprised in the first set of recommended items that is recommended by a first combination of NLP engines;
grouping one or more items into a second category based on an item comprised in the first set of recommended items that is recommended by a second combination of NLP engines;
grouping one or more items into a third category based on an item comprised in the first set of recommended items that is recommended by a third combination of NLP engines; and
grouping one or more items into a fourth category based on an item comprised in the first set of recommended items that is recommended by a NLP engine.

20. The one or more non-transitory machine-readable information storage mediums of claim 15, wherein the one or more instructions which when executed by the one or more hardware processors further cause:
updating the weightage of each of the plurality of NLP engines based on a comparison of (i) one or more items amongst the second set of recommended items, and (ii) a fifth set of items; and
sorting the second set of recommended items based on the updated weightage.
